(19) United States
(12) Patent Application Publication
(10) Pub. No.: US 2025/0146837 A1
(43) Pub. Date: May 8, 2025

(54) Device and Method for Detecting a Bypass Lane of a Signaling Unit

(71) Applicant: Bayerische Motoren Werke Aktiengesellschaft, Muenchen (DE)

(72) Inventors: Wolfgang HEMPEL, Sinzing (DE); Martin LIEBNER, Muenchen (DE); David PANNEN, Muenchen (DE)

(21) Appl. No.: 18/838,287

(22) PCT Filed: Feb. 9, 2023
(86) PCT No.: PCT/EP2023/053142

§ 371 Date: Aug. 14, 2024

(30) Foreign Application Priority Data
Feb. 15, 2022 (DE) 10-2022 103 458.5

(51) Int. Cl. G01C 21/00; G08G 1/01; G08G 1/052

(52) U.S. Cl. CPC G01C 21/3848; G08G 1/0137; G08G 1/052

(57) ABSTRACT

A device for detecting a bypass lane of a signaling unit is provided. The device is configured to determine driving data for a plurality of trips of one or more motor vehicles in an environment of the signaling unit, and to determine a subset of the plurality of trips on the basis of the driving data, in which a holding request of the signaling unit for holding at the signaling unit has not been followed. The device is further configured to detect a bypass lane of the signaling unit on the basis of the determined subset of trips.

### BACKGROUND AND SUMMARY

The invention relates to a device and a corresponding method for detecting a hitherto unknown bypass lane at a signaling unit.

A vehicle may have one or more driving functions that assist the driver of the vehicle in the guidance, in particular the longitudinal guidance and/or the lateral guidance, of the vehicle. An illustrative driving function to assist in the longitudinal guidance of a vehicle is the adaptive cruise control (ACC) function, which can be used to perform longitudinal guidance for the vehicle at a stipulated set or setpoint speed of travel and/or at a stipulated setpoint distance from a preceding vehicle traveling in front of the vehicle. The driving function can also be used at a signaling unit (in particular at traffic lights) at a traffic junction (for example, at an intersection) to bring about automated longitudinal guidance, for instance automated slowing, at the signaling unit.

A signaling unit at a junction (wherein the signaling unit has one or more signal transmitters) can be regarded on the basis of map data, the map data comprising one or more map attributes relating to a signaling unit to be regarded and/or relating to a junction. The quality of the driving function is typically dependent on the quality of the available map data.

The present document is concerned with the technical object of increasing the quality of map data relating to a signaling unit and/or relating to a junction in order to increase the comfort and/or safety of a driving function, in particular a driving function for automated longitudinal guidance at a signaling unit, or at a junction.

The object is achieved by each individual instance of the independent claims. Advantageous embodiments are described in the dependent claims, inter alia. It is pointed out that additional features of a patent claim dependent on an independent patent claim can form a separate invention, independent of the combination of all the features of the independent patent claim, that can be turned into the subject matter of an independent claim, a divisional application or a subsequent application without the features of the independent patent claim or only in combination with a subset of the features of the independent patent claim. This applies in the same manner to technical teachings described in the description that are able to form an invention independent of the features of the independent patent claims.

According to one aspect, a device (in particular a vehicle-external unit, for example, a server) for detecting a bypass lane of a signaling unit is described. The signaling unit may be, e.g., a traffic signal system (in particular traffic lights) having one or more signal transmitters and/or signal groups. Alternatively, the signaling unit may be a road sign (e.g., a stop sign). The signaling unit can signal a stop request to a vehicle in order to prompt the vehicle to stop at a stop position of the signaling unit. The stop request can be signaled, e.g., by a red signal transmitter or by a stop sign.

The signaling unit may be provided along a road used by a vehicle. The signaling unit may possibly be relevant for at least one lane of the road. In particular, the signaling unit may be designed to produce a stop request for at least one lane of the road. On the other hand, the signaling unit may possibly not be relevant for the road used by a vehicle at all (e.g., a signaling unit for pedestrians or for trams).

The signaling unit may be provided at a junction between multiple roads. However, the signaling unit may possibly also be provided along a road without a junction or may at least be visible therefrom. This may be the case, e.g., with a signaling unit for trains or streetcars that may be visible from a road section (also without a junction).

The signaling unit may be provided along the road in such a way that the signaling unit, in particular a stop request signaled by the signaling unit, can be picked up by an environment sensor (in particular by a camera) of a vehicle traveling on the road.

The device may be configured to determine trip data for a multiplicity of (manual) trips by one or more motor vehicles past and/or in the surroundings of the signaling unit. The individual trips may have been taken manually (in particular in terms of the longitudinal guidance of the vehicle) by a driver of the respective vehicle. The individual trips may be on the road that goes to the signaling unit and/or goes past the signaling unit. The trip data for a trip may relate to a route that goes to the signaling unit and/or goes past the signaling unit. The trip data for a trip can be sent from the respective vehicle to the device (e.g., via a (possibly wireless) communication connection).

The trip data for a trip of a vehicle may comprise odometry information relating to a motion, in particular relating to the speed, of the vehicle during the trip. The odometry information can indicate in particular the speed at which the vehicle has traveled past the signaling unit. Alternatively or additionally, the odometry information can indicate (possibly in a binary manner) whether or not the vehicle has performed a stopping action during the trip. Furthermore, the trip data can indicate whether or not the signaling unit signaled a stop request during the trip. For this purpose, the trip data may possibly comprise environment data from one or more environment sensors of the vehicle.

The device may furthermore be configured to take the trip data as a basis for determining a subset of the multiplicity of trips during which a stop request from the signaling unit to stop at the signaling unit was not heeded. In other words, the zero, one or more trips from the multiplicity of trips during which a stop request (detected by the vehicle) from the signaling unit was not heeded (by the driver of the vehicle) can be determined. The determined subset of trips can then be taken as a basis for reliably and robustly detecting a bypass lane of the signaling unit. A bypass lane in this instance may be a lane for which the signaling unit, in particular a signal group of the signaling unit detected by a vehicle, is not relevant.

The device may thus be configured to take trip data from a multiplicity of trips (e.g., from 10 or more, or from 50 or more trips) past a signaling unit as a basis for detecting whether the signaling unit is provided with a bypass lane for which the signaling unit is not relevant. Any lane for which the signaling unit is not relevant can be referred to as a bypass lane (even if the signaling unit is not relevant for any lane of the road section, e.g., because the signaling unit is relevant for pedestrians or for trains, and is merely visible from the road section).

The device may be configured to take the detected bypass lane as a basis for creating and/or updating map data relating to the signaling unit. Alternatively or additionally, a map attribute for a virtual signal group of the signaling unit (which can generate no stop requests) for the detected bypass lane can be included in the map data. The detected bypass lane can thus be recorded in map data, the map data being able to be used by a vehicle guidance system for automated longitudinal and/or lateral guidance of a vehicle. This enables the quality and safety of the vehicle guidance system to be increased.

The device may be configured to take the trip data as a basis for determining a basic set of the multiplicity of trips during which there was a stop request from the signaling unit. In other words, the trips from the multiplicity of trips during which there was a stop request for the vehicle (and said stop request was detected by the respective vehicle) can be selected.

The trip data for a trip of a vehicle may comprise environment data relating to the environment of the vehicle during the trip that were acquired by one or more environment sensors (in particular cameras) of the vehicle. The basic set can then be reliably determined on the basis of the environment data for the multiplicity of trips. This can involve taking the environment data relating to the environment of a vehicle during a trip as a basis for ascertaining whether or not the signaling unit signaled a stop request during the trip (e.g., because the signal transmitter of the signaling unit was “red”). The respective trip can be included in the basic set if it is ascertained that the signaling unit did signal a stop request. On the other hand, the respective trip may not be included in the basic set if it is ascertained that the signaling unit did not signal a stop request. This enables the basic set to be determined precisely.

The subset of trips during which the stop request was not heeded can be compared with the basic set in order to detect a bypass lane of the signaling unit. The device may, in particular, be configured to take the subset as a basis for determining a proportion of trips from the basic set during which there was a stop request from the signaling unit but said request was not heeded by the respective vehicle. The determined proportion can then be compared with a proportion threshold value in order to detect a bypass lane of the signaling unit. The device may, in particular, be configured to ascertain that there is a lane, in particular a bypass lane, at the signaling unit for which the signaling unit is not relevant if the determined proportion is equal to or greater than the proportion threshold value. On the other hand, it may possibly be ascertained that there is no bypass lane at the signaling unit if the determined proportion is less than the proportion threshold value. This enables a bypass lane to be detected particularly robustly.

The device may be configured to take the odometry information for a trip of a vehicle as a basis for detecting that the vehicle has not dropped below a predefined limit speed (e.g., 5 km/h or more, or 10 km/h or more) for the entire trip. This can then be reliably taken as a basis for ascertaining that the vehicle has not stopped at the signaling unit, in particular at the stop position of the signaling unit, during the trip (and thus a stop request that may have been available from the signaling unit was not heeded).

According to another aspect, a (road) motor vehicle (in particular an automobile or a truck or a bus or a motorcycle) is described that comprises the vehicle guidance system for operating a driving function described in this document and/or that is designed to acquire trip data relating to a trip past a signaling unit and to deliver said trip data (to a vehicle-external unit).

According to another aspect, a method for detecting a bypass lane of a signaling unit (e.g., a traffic signal system or a road sign) is described. The method comprises determining trip data for a multiplicity of trips by one or more motor vehicles past the signaling unit. The trip data for a trip of a vehicle may in this instance comprise odometry information relating to a motion, in particular relating to a speed, of the vehicle during the trip. The method furthermore comprises determining, on the basis of the trip data, a subset of the multiplicity of trips during which a stop request (detected by the vehicle) from the signaling unit to stop at the signaling unit was not heeded. Additionally, the method comprises detecting a bypass lane of the signaling unit on the basis of the determined subset of trips.

According to another aspect, a software (SW) program is described. The SW program may be configured to be executed on a processor (e.g., on a control unit of a vehicle and/or on a vehicle-external unit) and to thereby carry out at least one of the methods described in this document.

According to another aspect, a storage medium is described. The storage medium may comprise an SW program that is configured to be executed on a processor and to thereby carry out at least one of the methods described in this document.

The term “automated driving” may be understood within the context of the document to mean driving with automated longitudinal or lateral guidance or autonomous driving with automated longitudinal and lateral guidance. Automated driving may be for example driving for an extended period of time on the freeway or driving for a limited period of time when parking or maneuvering. The term “automated driving” covers automated driving with any desired level of automation. Illustrative levels of automation are assisted, partially automated, highly automated or fully automated driving. These levels of automation have been defined by the German Federal Highway Research Institute (BASt) (see BASt publication “Forschung kompakt”, issue November 2012). In the case of assisted driving, the driver performs the longitudinal or lateral guidance on an ongoing basis, while the system undertakes the respective other function within certain boundaries. In the case of partially automated driving (TAF), the system undertakes the longitudinal and lateral guidance for a certain period of time and/or in specific situations, the driver needing to monitor the system on an ongoing basis as in the case of assisted driving. In the case of highly automated driving (HAF), the system undertakes the longitudinal and lateral guidance for a certain period of time without the driver needing to monitor the system on an ongoing basis; however, the driver must be capable of taking over vehicle guidance within a certain time. In the case of fully automated driving (VAF), the system can automatically cope with driving in all situations for a specific application; a driver is no longer needed for this application. The aforementioned four levels of automation correspond to SAE levels 1 to 4 of SAE standard J3016 (SAE—Society of Automotive Engineering). By way of example, highly automated driving (HAF) corresponds to level 3 of SAE standard J3016. Furthermore, SAE J3016 also has provision for SAE level 5 as the highest level of automation, which is not included in the definition from the BASt. SAE level 5 corresponds to driverless driving, in which the system can automatically cope with all situations throughout the trip in the same way as a human driver; a driver is generally no longer needed. The aspects described in this document relate in particular to a driving function, or a driver assistance function, designed according to SAE level 2.

It should be noted that the methods, devices and systems described in this document may be used alone or in combination with other methods, devices and systems described in this document. In addition, any aspects of the methods, devices and systems described in this document may be combined with one another in a variety of ways. In particular, the features of the claims may be combined with one another in a variety of ways. Furthermore, features shown between parentheses may be understood as optional features.

The invention is described in more detail below on the basis of exemplary embodiments, in which

### BRIEF DESCRIPTION OF THE DRAWINGS

FIG. 1 shows illustrative components of a vehicle;

FIG. 2a shows an illustrative traffic signal system;

FIG. 2b shows an illustrative road sign;

FIG. 3 shows an illustrative traffic situation;

FIGS. 4a and 4b show illustrative bypass lanes at a signaling unit; and

FIG. 5 shows a flowchart for an illustrative method for detecting a bypass lane at a signaling unit.

### DETAILED DESCRIPTION OF THE DRAWINGS

As explained at the outset, the present document is concerned with increasing the reliability, availability and/or comfort of a driving function, in particular a driver assistance system, of a vehicle, e.g., in connection with a signaling unit at a junction of the road used by the vehicle. In particular, the present document is concerned with delivering precise map data for operating a driving function.

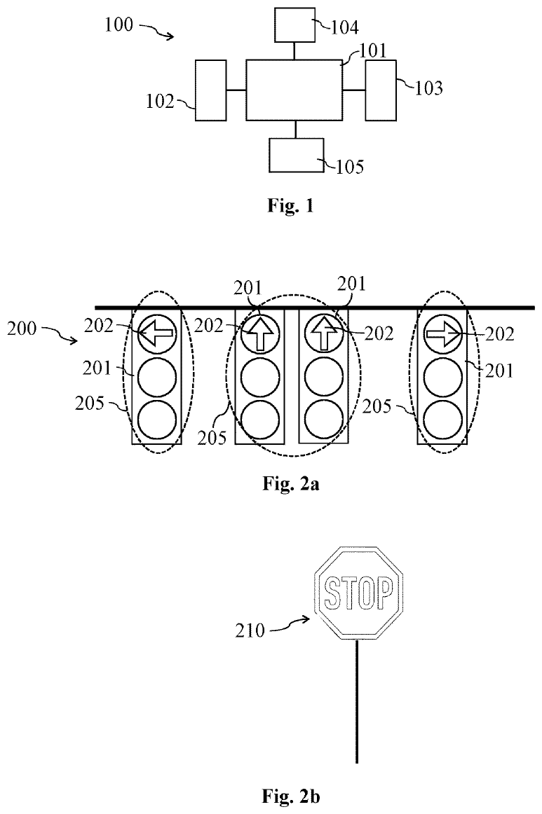

FIG. 1 shows illustrative components of a vehicle 100. The vehicle 100 comprises one or more environment sensors 103 (e.g., one or more image cameras, one or more radar sensors, one or more lidar sensors, one or more ultrasonic sensors, etc.) that are configured to acquire environment data relating to an environment of the vehicle 100 (in particular relating to the environment in front of the vehicle 100 in the direction of travel). In addition, the vehicle 100 comprises one or more actuators 102 that are configured to influence the longitudinal and/or lateral guidance of the vehicle 100. Illustrative actuators 102 are: a braking system, a drive motor, a steering, etc.

The (control) device 101 of the vehicle 100 may be configured to take the sensor data from the one or more environment sensors 103 (i.e., to take the environment data) as a basis for delivering a driving function, in particular a driver assistance function. By way of example, the sensor data can be taken as a basis for detecting an obstacle on the travel trajectory of the vehicle 100. The control device 101 can then trigger one or more actuators 102 (e.g., the braking system) in order to slow the vehicle 100 in an automated manner and thereby prevent the vehicle 100 from colliding with the obstacle.

In the course of the automated longitudinal guidance of a vehicle 100, one or more signaling units (e.g., a traffic signal system and/or a road sign) on the road or street used by the vehicle 100 can be regarded besides a preceding vehicle. In particular the status of a traffic signal system or set of traffic lights can be regarded, with the result that, at a red traffic light relevant to the particular (planned) direction of travel, the vehicle 100 effects slowing to the stop line of the traffic lights and/or speeds up (possibly again) for a green traffic light in an automated manner.

Traffic signal systems can be of very heterogeneous design in different countries and may moreover be of different complexity in terms of the direction-of-travel/traffic signal assignment. As such, different directions of travel can be controlled collectively by a first group of signals or by a first signal group and another direction can be controlled by a different signal group. The repeating signals of a signal group may moreover be geographically situated at different points of an intersection. It may therefore be difficult for a control device 101 (also referred to as a vehicle guidance system in this document) to take the sensor data as a basis for detecting which one or more signals from a traffic signal system at an intersection are relevant for the planned direction of travel of the vehicle 100 and which are not (in particular if the vehicle 100 is still a relatively long way from the traffic signal system).

FIG. 2a shows an illustrative traffic signal system 200. The traffic signal system 200 depicted in FIG. 2a has four different signal transmitters 201 provided at different positions along an approach road to an intersection. The left-hand signal transmitter 201 has an arrow 202 to the left, and thus indicates that this signal transmitter 201 forms a signal group 205 for left turns. The two middle signal transmitters 201 have an upward arrow 202 (or no arrow 202) and thus indicate that these two signal transmitters 201 apply to driving straight ahead. The individual light signals of these two signal transmitters 201 form a signal group 205 for driving straight ahead. In addition, the right-hand signal transmitter 201 has an arrow 202 to the right, and thus indicates that this signal transmitter 201 forms a signal group 205 for right turns.

The traffic signal system 200 depicted in FIG. 2a is only one example of many different possible embodiments of a traffic signal system 200. A traffic signal system 200 may have a relatively large number of different forms of features. Illustrative features are.
the number of signal transmitters 201 and/or signal groups 205;
the positions of the one or more signal transmitters 201; and/or
the assignment of a signal transmitter 201 to a possible direction of travel through an intersection.

FIG. 2b shows an illustrative stop sign as a road sign 210 that controls right of way at a traffic junction, in particular at an intersection. The control device 101 of the vehicle 100 may be configured to take the sensor data from the one or more environment sensors 103 (i.e., to take the environment data) and/or to take digital map information (i.e., map data) as a basis for detecting a road sign 210 relevant for the right of way of the vehicle 100 on the street or road used by the vehicle 100.

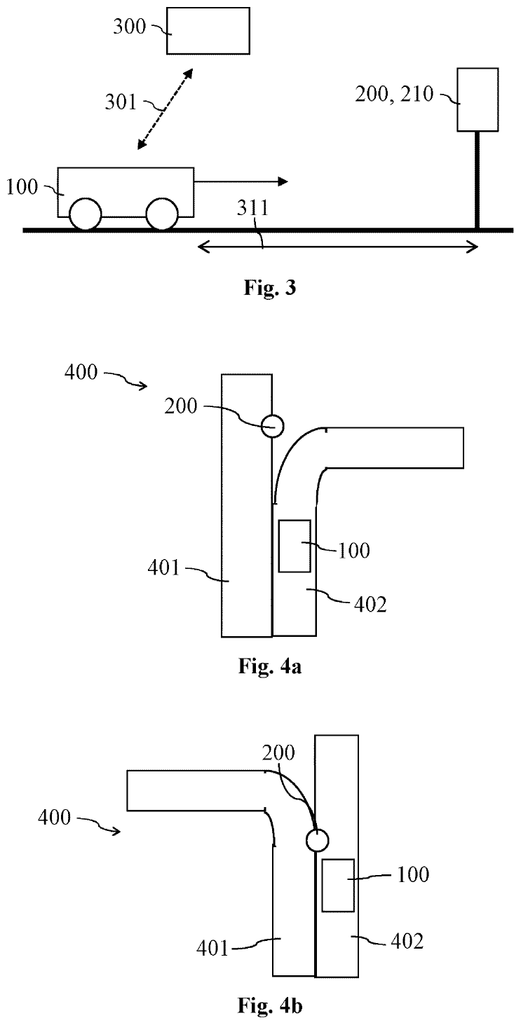

FIG. 3 shows, by way of illustration, a vehicle 100 that is moving toward a signaling unit 200, 210 (in particular toward a traffic signal system 200 and/or toward a road sign 210) on a road. The one or more environment sensors 103 of the vehicle 100 may be configured to acquire sensor data (in particular image data) relating to the signaling unit 200, 210. The sensor data can then be analyzed (e.g., by means of an image analysis algorithm) in order to ascertain forms of one or more features of the signaling unit 200, 210. In particular, the sensor data can be taken as a basis for determining whether the signaling unit 200, 210 is a traffic signal system 200 or a road sign 210. Furthermore, it is possible to determine which signal transmitter 201 and/or which signal group 205 of the traffic signal system 200 is relevant for the (planned) direction of travel of the vehicle 100. It may, however, be difficult to determine the specific relevant signal transmitter 201 and/or the specific relevant signal group 205. In addition, the (signaling) state of the relevant signal transmitter 201 (e.g., the color, for instance red, amber or green) can be determined.

The quality and/or reliability with which the environment data can be taken as a basis for determining the form of a feature of a signaling unit 200, 210 are typically dependent on the distance 311 of the vehicle 100 from the signaling unit 200, 210. In addition, current weather conditions also typically have a significant influence on the quality and/or reliability of the determined form of a feature. The quality and/or reliability may also be different for different features.

The vehicle 100 may have a storage unit 104 that stores digital map data relating to the street network used by the vehicle 100. The map data can indicate forms of one or more features of one or more signaling units 200, 210 at different traffic junctions in the street or road network as attributes. In particular, the map data can indicate for a traffic signal system 200 the assignment of the one or more signal transmitters 201 or signal groups 205 to different possible directions of travel. In other words, the map data can indicate which signal transmitter 201 or which signal group 205 is responsible for clearance for which direction of travel. The map data may possibly be received on the vehicle 100 by means of a communication unit 105 of the vehicle 100 via a wireless communication connection (e.g., a WLAN or LTE communication connection).

The control device 101 of the vehicle 100 may be configured to determine (e.g., on the basis of the current position of the vehicle 100 and on the basis of a planned route of travel and/or on the basis of the environment data from the one or more environment sensors 103) that the vehicle 100 is approaching a signaling unit 200, 210 ahead. In addition, the control device 101 can take the (stored and/or received) map data as a basis for determining the forms of one or more features of the signaling unit 200, 210 ahead. In particular, the map data can be taken as a basis for determining which signal transmitter 201 or which signal group of a traffic light system 200 is associated with the current or planned direction of travel of the vehicle 100. Additionally, the environment data can be taken as a basis for determining the current status of the associated signal transmitter 201 or the associated signal group. This can then be taken as a basis for reliably and comfortably performing an automated driving function (e.g., automated longitudinal guidance of the vehicle 100). In particular, taking into consideration the map data allows the forms of the one or more relevant features of a signaling unit 200 to be determined even when the vehicle 100 is at a relatively great distance 311 from the signaling unit 200, allowing the reliability, availability and comfort of an automated driving function to be increased.

A vehicle 100 may be configured to use information relating to a signaling unit 200, 210 that is or was passed during a trip by the vehicle 100 to create and/or add to the map data. The map data can be created and/or added to locally by the vehicle 100 and/or centrally by a vehicle-external unit 300 (e.g., by a backend server) (see FIG. 3). In direct proximity to a signaling unit 200, 210, the one or more environment sensors 103 of a vehicle 100 can typically acquire environment data that precisely indicate the form of one or more features of the signaling unit 200, 210. In particular, in direct proximity, the acquired environment data can be taken as a basis for precisely and reliably ascertaining the association between signal transmitters 201 or signal groups 205 and possible directions of travel.

The vehicle 100 may be configured to transfer the determined information (e.g., the environment data and/or the determined forms of the one or more features) to the vehicle-external unit 300 via a (possibly wireless) communication connection 301 (in conjunction with an identifier for the respective signaling unit 200, 210, for instance in conjunction with the position of the signaling unit 200, 210). The vehicle-external unit 300 can then take the information delivered by a multiplicity of vehicles 100 as a basis for creating and/or updating map data that indicate the forms of one or more features for each of a multiplicity of different signaling units 200, 210 as attributes. The map data can then be delivered to the individual vehicles 100 in order (as outlined above) to assist in the operation of an automated driving function.

FIGS. 4a and 4b each show an illustrative junction 400 having a signaling unit 200 in a first lane 401. In addition, the junction 400 has a bypass lane 402 that goes past the signaling unit 200 (in particular the signal transmitter 201 of the signaling unit 200). In the example illustrated in FIG. 4a, the bypass lane 402 is a right-turn lane, whereas the signaling unit 200 is provided in a straight-ahead lane. In the example illustrated in FIG. 4b, the bypass lane 402 is a straight-ahead lane, whereas the signaling unit 200 is provided in a left-turn lane (what is known as a “protected left turn” junction 400).

The vehicle guidance system 101 of a vehicle 100 may be configured to take the environment data from the one or more environment sensors 103 of the vehicle 100 as a basis for detecting a signaling unit 200 at the junction 400 ahead. In addition, the signaling state of the signaling unit 200 can be determined. Automated longitudinal guidance can then be produced at the junction 400 on the basis of the detected signaling state of the signaling unit 200. In particular, automated slowing of the vehicle 100 can be produced e.g. for red (i.e. when there is a stop request from the signaling unit 200).

At a junction 400 having a bypass lane 402, the signaling state of the signaling unit 200 should be regarded only if the vehicle 100 is in a lane 401 for which the signaling unit 200 is relevant. On the other hand, the signaling unit 200 should be disregarded if the vehicle 100 is in the bypass lane 402.

The vehicle guidance system 101 may be configured to ascertain (e.g., to receive from a vehicle-external unit 300) map data relating to the junction 400. The map data may comprise a map attribute relating to the at least one signaling unit 200 of the junction 400. The map attribute for a signaling unit 200 can indicate the position of the signaling unit 200 (relative to a stop line of the junction 400 and/or relative to one or more lanes 401, 402 of the junction 400).

The map data for the junction 400 can furthermore indicate that the junction 400 has a bypass lane 402 in which a vehicle 100 can travel, in particular can have longitudinal and/or lateral guidance performed for it in an automated manner, without regard to the signaling state of the one or more signaling units 200 of the junction 400. The map data may have, e.g., a map attribute for a fictitious or virtual signal transmitter 201 or for a virtual signal group 205 for the bypass lane 402. The map attribute can indicate that the fictitious or virtual signal transmitter 201 or the virtual signal group 205 for the bypass lane 402 can have only a single signaling state (e.g., “Green”).

The vehicle guidance system 101 may therefore be configured to take the map data for the junction 400 as a basis for determining that the junction 400 has a bypass lane 402 (possibly with a fictitious or virtual signal transmitter 201). In addition, the vehicle guidance system 101 may be configured to ascertain (on the basis of the environment data and/or on the basis of the position data) that the vehicle 100 is in the bypass lane 402. The automated longitudinal and/or lateral guidance of the vehicle 100 at the junction 400 can then be performed without regard to the one or more signaling units 200, in particular without regard to the signaling state of the one or more signaling units 200. As such, e.g., erroneous slowing of the vehicle 100 at the junction 400 can be reliably prevented if the vehicle 100 is in the bypass lane 402.

The vehicle-external unit 300 may be configured to determine environment data relating to the junction 400 from one or more vehicles 100 and/or for one or more trips past the junction 400. The environment data may have been transmitted to the vehicle-external unit 300, e.g., via a communication unit 301. The vehicle-external unit 300 may furthermore be configured to analyze the environment data in order to detect whether or not the junction 400 has a bypass lane 402. In particular, it is possible to verify whether the junction 400 has a lane that goes past to the right of a signaling unit 200 (in particular to the right of all of the signaling units 200 of the junction 400, or the approach road to the junction 400). Such a lane can be identified as a bypass lane 402.

The vehicle-external unit 300 may furthermore be configured to create or update map data relating to the junction 400. In particular, a map attribute relating to the detected bypass lane 402 can be included in the map data. Furthermore, a map attribute for a fictitious or virtual signal transmitter 201 or for a fictitious or virtual signal group 205 for the bypass lane 402 can be included in the map data. The map data can then be used, as outlined above, by a vehicle guidance system 101 in order to produce automated longitudinal and/or lateral guidance for a vehicle 100 at the junction 400. This enables the quality, comfort and safety of the automated longitudinal and/or lateral guidance of a vehicle 100 at the junction 400 to be increased.

The vehicle-external unit 300 may thus be configured to take the data delivered by vehicles 100 about trips past a junction 400 as a basis for detecting a bypass lane 402. This can involve evaluating the travel trajectories of the individual vehicles 100 at the junction 400 in order to detect a bypass lane 402. This approach may possibly not be enough to robustly detect a bypass lane 402.

The vehicle-external unit 300 may be configured to determine trip data for a multiplicity of trips past a junction 400. The trip data for a trip can indicate:
the travel trajectory of the vehicle 100 at the junction 400;
state information relating to the signaling state of the signaling unit 200, 210 at the junction 400 (e.g., the color of the signaling unit 200, 210); and/or
odometry information relating to the motion of the vehicle 100 during the trip (e.g., the speed of the vehicle 100 over the course of time during the trip);
information about whether or not the vehicle 100 has stopped at the signaling unit 200, 210 of the junction 400.

The trip data can be analyzed, and a basic set of trips (from the multiplicity of trips) during which the vehicle 100 has detected a stop request, prescribed by the signaling unit 200, 210, to stop at the signaling unit 200, 210 can be determined. In particular, the proportion of trips during which there was a stop request but this stop request was not heeded by the respective vehicle 100 can be determined. If this proportion reaches or exceeds a particular proportion threshold value, it can be concluded that the junction 400 has another lane 402 for which the detected signaling unit 200, 210 is not relevant. In particular, a bypass lane 402 relating to the signaling unit 200, 210 can be detected. A map attribute for this lane 402 can then be included in the map data for the junction 400.

Non-stopping actions (i.e., actions during which vehicles 100 have not stopped) at a red signal transmitter 201 can thus be used to detect a lane 402 that is not regulated by the signal transmitter 201. This involves making the assumption that the majority of drivers adhere to applicable traffic regulations. If a significant proportion of drivers going through on red is detected on the basis of the trip data, it can be assumed that there is at least one signal transmitter 201 (e.g., at least one set of traffic lights) and therefore at least one signal group 205 that is not valid for at least one lane 402. In other words, it can therefore be established that there are at least two different signal groups 205 or at least one unregulated lane 402 (e.g., a bypass lane).

Trip data for a multiplicity of trips on a specific approach road to a signaling unit 200, 210 (possibly at a junction 400) can thus be determined.

The respective odometry information from the trip data for the individual trips can be taken as a basis for ascertaining for each transit whether the speed while transiting the approach road was always greater than a specific limit speed. It is therefore possible to identify all transits during which the respective vehicle 100 did not stop on the approach road to the signaling unit 200, 210. Of these transits, the proportion of those transits during which a stop request from the signaling unit 200, 210 was detected (on the basis of the environment data) can be determined. If the proportion of transits with a detected stop request during which the respective vehicle 100 did not stop is above a specific threshold value, it can be concluded that this approach road is not a simple approach road with exactly one signal group 205 valid for all lanes 401, 402 of the approach road. This approach road can thus be stored in the map data as a complex intersection 400. As a result, automated slowing at this junction 400 on detection of a red traffic light can then be prevented during operation of a vehicle guidance system 101. Furthermore, the task of vehicle longitudinal control and/or the decision for or against a stopping action can be handed over to the driver of the vehicle 100 (at an early stage).

Similarly, respective trip data for a multiplicity of trips can be determined and evaluated for different road sections along which a signaling unit 200, 210 with a stop request is detected (e.g., on the basis of the environment data from the respective vehicles 100). The detected signaling units 200, 210 may possibly also be pedestrian lights, tram lights, bicycle traffic lights or red warning lights, which are not relevant for at least one lane 402 of the road section for a vehicle 100. The respective trip data can then be taken as a basis for determining whether the respective road section has at least one lane 402 for which the detected signaling unit 200, 210 is not relevant. This information can be stored in the map data for the respective road section. This enables the quality and safety of a vehicle guidance system 101 to be increased.

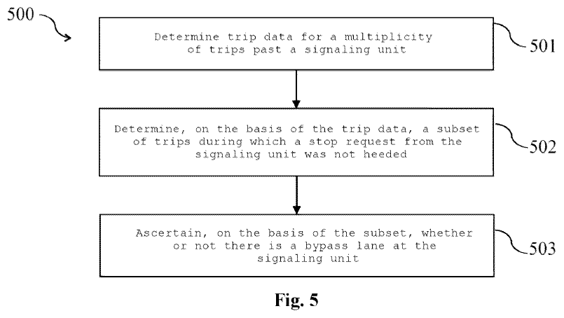

FIG. 5 shows a flowchart for a (possibly computer-implemented) method 500 for detecting a bypass lane 402 of a signaling unit 200, 210. In particular, it is possible to detect that the signaling unit 200, 210 is provided with a lane for which the signaling unit 200, 210, in particular for which the one or more signal groups 205 of the signaling unit 200, 210, is not relevant (and thus also does not have to be paid attention by vehicles 100).

The method 500 comprises determining 501 trip data for a multiplicity of (manually taken) trips by one or more motor vehicles 100 past and/or in the surroundings of the signaling unit 200, 210. The individual trips can take place on an approach road to the signaling unit 200, 210. The individual trips can each go past the signaling unit 200, 210 (in particular the stop position of the signaling unit 200, 210). Trip data can be determined for 10 or more, or for 50 or more, trips.

The trip data for a trip of a vehicle 100 may in each case comprise odometry information relating to the motion, in particular relating to the speed, of the vehicle 100 during the trip. The odometry information may possibly (only) indicate whether or not the vehicle 100 has stopped during the trip. Furthermore, the trip data for a trip can indicate whether or not the vehicle 100 detected a stop request from the signaling unit 200, 210. A stop request can be signaled dynamically by the color of a signal transmitter 201 of a traffic signal system 200. Alternatively, a stop request can be signaled statically by a road sign 210 (e.g., by a stop sign).

The method 500 furthermore comprises determining 502, on the basis of the trip data, a subset of the multiplicity of trips during which a stop request from the signaling unit 200, 210 to stop at the signaling unit 200, 210 was not heeded. In particular, the proportion of trips during which there is a stop request but the stop request was not heeded can be determined.

In addition, the method 500 comprises detecting 503 a bypass lane 402 of the signaling unit 200, 210 on the basis of the determined subset of trips, in particular on the basis of the determined proportion of trips, during which a detected stop request was not heeded (by the driver of the respective vehicle 100). The bypass lane 402 may be any lane of a road for which the signaling unit 200, 210 is not relevant.

The measures described in this document enable an additional bypass lane 402 at a signaling unit 200, 210 to be detected efficiently and robustly in order to improve the quality of map data relating to a road network. The map data relating to a detected bypass lane 402 can then be used by a vehicle guidance system 101 of a vehicle 100 to produce comfortable and safe automated longitudinal and/or lateral guidance at the signaling unit 200, 210.

The present invention is not restricted to the exemplary embodiments shown. In particular, it should be remembered that the description and the figures are intended only to illustrate the principle of the proposed methods, devices and systems.

1.-10. (canceled)

11. An apparatus for detecting a bypass lane of a signaling unit, wherein the apparatus is configured to:
determine trip data for a plurality of trips by a motor vehicle in surroundings of the signaling unit, wherein the trip data for a trip of the motor vehicle include odometry information relating to a motion, including a speed, of the motor vehicle during the trip;
determine, based on the trip data, a subset of the plurality of trips during which a stop request from the signaling unit to stop at the signaling unit was not heeded; and
detect the bypass lane of the signaling unit based on the determined subset of trips.

12. The apparatus according to claim 11, wherein the apparatus is configured to:
determine, based on the trip data, a basic set of the plurality of trips during which there was the stop request from the signaling unit; and
compare the subset with the basic set in order to detect the bypass lane of the signaling unit.

13. The apparatus according to claim 12, wherein
the trip data for the trip of the motor vehicle include environment data relating to an environment of the motor vehicle during the trip that were acquired by one or more environment sensors of the motor vehicle; and
the apparatus is configured to determine the basic set based on the environment data for the plurality of trips.

14. The apparatus according to claim 13, wherein the apparatus is configured to:
determine, based on the environment data relating to the environment of the motor vehicle during the trip, whether or not the signaling unit signaled a 1 during the trip; and
include the trip in the basic set in a case in which the signaling unit did signal the stop request; and/or
not include the trip in the basic set in a case in which the signaling unit did not signal the stop request.

15. The apparatus according to claim 12, wherein the apparatus is configured to:
determine, based on the subset, a proportion of trips from the basic set during which there was the stop request from the signaling unit but the request was not heeded by the motor vehicle; and
compare the determined proportion with a proportion threshold value in order to detect the bypass lane of the signaling unit.

16. The apparatus according to claim 13, wherein the apparatus is configured to:
determine, based on the subset, a proportion of trips from the basic set during which there was the stop request from the signaling unit but the request was not heeded by the motor vehicle; and
compare the determined proportion with a proportion threshold value in order to detect the bypass lane of the signaling unit.

17. The apparatus according to claim 14, wherein the apparatus is configured to:
determine, based on the subset, a proportion of trips from the basic set during which there was the stop request from the signaling unit but the request was not heeded by the motor vehicle; and
compare the determined proportion with a proportion threshold value in order to detect the bypass lane of the signaling unit.

18. The apparatus according to claim 15, wherein the apparatus is configured to:
determine that there is the bypass lane at the signaling unit for which the signaling unit is not relevant where the determined proportion is equal to or greater than the proportion threshold value; and/or
determine that there is no bypass lane at the signaling unit where the determined proportion is less than the proportion threshold value.

19. The apparatus according to claim 11, wherein the apparatus is configured to:
determine, based on the odometry information for the trip of the motor vehicle, that the motor vehicle has not dropped below a predefined limit speed for an entirety of the trip; and
determine that the motor vehicle has not stopped at a stop position of the signaling unit during the trip, based on a determination that the motor vehicle has not dropped below the predefined limit speed for the entirety of the trip.

20. The apparatus according to claim 12, wherein the apparatus is configured to:
determine, based on the odometry information for the trip of the motor vehicle, that the motor vehicle has not dropped below a predefined limit speed for an entirety of the trip; and
determine that the motor vehicle has not stopped at a stop position of the signaling unit during the trip, based on a determination that the motor vehicle has not dropped below the predefined limit speed for the entirety of the trip.

21. The apparatus according to claim 13, wherein the apparatus is configured to:
determine, based on the odometry information for the trip of the motor vehicle, that the motor vehicle has not dropped below a predefined limit speed for an entirety of the trip; and
determine that the motor vehicle has not stopped at a stop position of the signaling unit during the trip, based on a determination that the motor vehicle has not dropped below the predefined limit speed for the entirety of the trip.

22. The apparatus according to claim 11, wherein the apparatus is configured to:
create and/or update map data relating to the signaling unit based on the detected bypass lane; and/or
include a map attribute for a virtual signal group of the signaling unit for the detected bypass lane in the map data.

23. The apparatus according to claim 12, wherein the apparatus is configured to:
create and/or update map data relating to the signaling unit based on the detected bypass lane; and/or
include a map attribute for a virtual signal group of the signaling unit for the detected bypass lane in the map data.

24. The apparatus according to claim 13, wherein the apparatus is configured to:
create and/or update map data relating to the signaling unit based on the detected bypass lane; and/or
include a map attribute for a virtual signal group of the signaling unit for the detected bypass lane in the map data.

25. The apparatus according to claim 11, wherein the bypass lane is a lane for which a signal group of the signaling unit detected by the motor vehicle is not relevant.

26. The apparatus according to claim 12, wherein the bypass lane is a lane for which a signal group of the signaling unit detected by the motor vehicle is not relevant.

27. The apparatus according to claim 13, wherein the bypass lane is a lane for which a signal group of the signaling unit detected by the motor vehicle is not relevant.

28. A method for detecting a bypass lane of a signaling unit, the method comprising:
determining trip data for a plurality of trips by a motor vehicle in surroundings of the signaling unit, wherein the trip data for a trip of the motor vehicle include odometry information relating to a motion, including a speed, of the motor vehicle during the trip;
determining, based on the trip data, a subset of the plurality of trips during which a stop request from the signaling unit to stop at the signaling unit was not heeded; and
detecting the bypass lane of the signaling unit based on the determined subset of trips.
